(19) United States
(12) Patent Application Publication
(10) Pub. No.: US 2014/0362043 A1
(43) Pub. Date: Dec. 11, 2014

(54) TOUCH PANEL

(71) Applicant: WINTEK CORPORATION, Taichung City (TW)

(72) Inventors: Kuan-Yu Chu, Taichung City (TW); Chun-Chin Chang, Taichung City (TW); Chen-Fu Huang, Taichung City (TW); Ming-Wu Chen, Nantou County (TW); Chin-Pei Hwang, Taichung City (TW); Kuo-Chang Su, Taichung City (TW); Chin-Chang Liu, Taichung City (TW); Siang-Lin Huang, Taichung City (TW); Ming-Shan Lai, Taichung City (TW)

(21) Appl. No.: 14/301,350

(22) Filed: Jun. 11, 2014

(30) Foreign Application Priority Data
Jun. 11, 2013 (TW) 102120787
Jul. 9, 2013 (CN) 201310286342.X

(51) Int. Cl. G06F 3/046

(52) U.S. Cl. CPC G06F 3/046
USPC 345/174

(57) ABSTRACT

The present invention discloses a touch panel, which includes a substrate, a plurality of first axis electrodes, a plurality of second axis electrodes and an insulation structure. The first axis electrodes are disposed on the substrate along a first direction and each of the first axis electrodes includes a plurality of first sub electrodes and a plurality of connection structures. Each of the connection structures is at least partially disposed between each of the first sub electrodes and the substrate, and is electrically connected to two adjacent first sub electrodes. Each of the connection structures includes a first metal layer and a low reflective layer disposed between the substrate and the first metal layer. The low reflective layer of the present invention is applied to reduce the visibility of the connection structures, as well as to enhance the reliability of the touch panel.

### BACKGROUND OF THE INVENTION

1. Field of the Invention

The present invention relates to a touch panel, and more particularly, to a touch panel comprising a connection structure made of a metal layer and a low reflective layer.

2. Description of the Prior Art

Recently, various technologies including the resistance type, the capacitance type and the optical type. Concerning the capacitive touch panel, owing to its outstanding characteristics, such as high accuracy, multi-touch property, better endurance and high touch resolution, the capacitive touch panel has become a mainstream technology in the end consumer electronics. The capacitive touch panel uses sensing electrodes to detect capacitance variations at the corresponding touch points and uses connection lines, which are electrically connected to electrodes along different directional axes, to transmit the signals so as to complete the whole touch sensing and positioning process. Referring to FIG. 1 and FIG. 2, a conventional touch panel 100 is shown, a plurality of first sub electrodes 120S arranged in rows along a first direction X and a plurality of second axis electrodes 120Y extending along a second direction Y are disposed on a substrate 110 and usually made of transparent conductive material, such as indium tin oxide (ITO). In the first direction X, two adjacent sub electrodes 120S are electrically connected to each other via a connection line 140 to form a plurality of first axis electrodes 120X extending along the first direction X. To prevent from electrical connections between the first axis electrodes 120X and the second axis electrodes 120Y, an insulator 130 is formed between the connection line 140 and the second axis electrodes 120Y in a vertical projected direction Z. General speaking, in order to reduce the entire impedance of the first axis electrodes 120X, the connection lines 140 are fabricated with metal having relatively low resistivity. However, the connection lines 140 fabricated with metal with light reflection feature such that the connection lines 140 are easy to be seen from a surface of the touch panel 100 and then interfere with the visual effect of the touch panel 100. Also, since the connection lines 140 cross over the insulators 130 respectively to contact the first sub electrodes 120S, the fabrication of the connection lines 140 may be affected by an uneven edge of the insulator 130 such that the fracture of the connection lines 140 may happen to decrease the yield and the reliability of the touch panel 100.

### SUMMARY OF THE INVENTION

It is one of the objectives of the present invention to provide a touch panel having a metal layer and a low reflective layer disposed in a connection structure electrically connected two sub electrodes, and having the connection structure at least partially disposed between the sub electrodes and a substrate, so that it is capable of reducing the visibility of the connection structures and increasing the reliability of the touch panel while reducing the impendence by employing the metal layer.

To achieve the purpose described above, the present invention provides a touch panel comprising a substrate, a plurality of first axis electrodes, a plurality of second axis electrodes and an insulation structure. The first axis electrodes are disposed on the substrate and extend along a first direction. Each of the first axis electrodes includes a plurality of first sub electrodes and a plurality of connection structures. Each of the connection structure is at least partially disposed between the first sub electrodes and the substrate, and is electrically connected to two adjacent first sub electrodes. Each of the connection structures includes a first metal layer and a low reflective layer disposed between the first metal layer and the substrate. The second axis electrodes are disposed on the substrate and extend along a second direction. The first direction is not parallel to the second direction. The insulation structure is at least partially disposed between the second axis electrodes and the connection structures.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram illustrating a conventional touch panel.

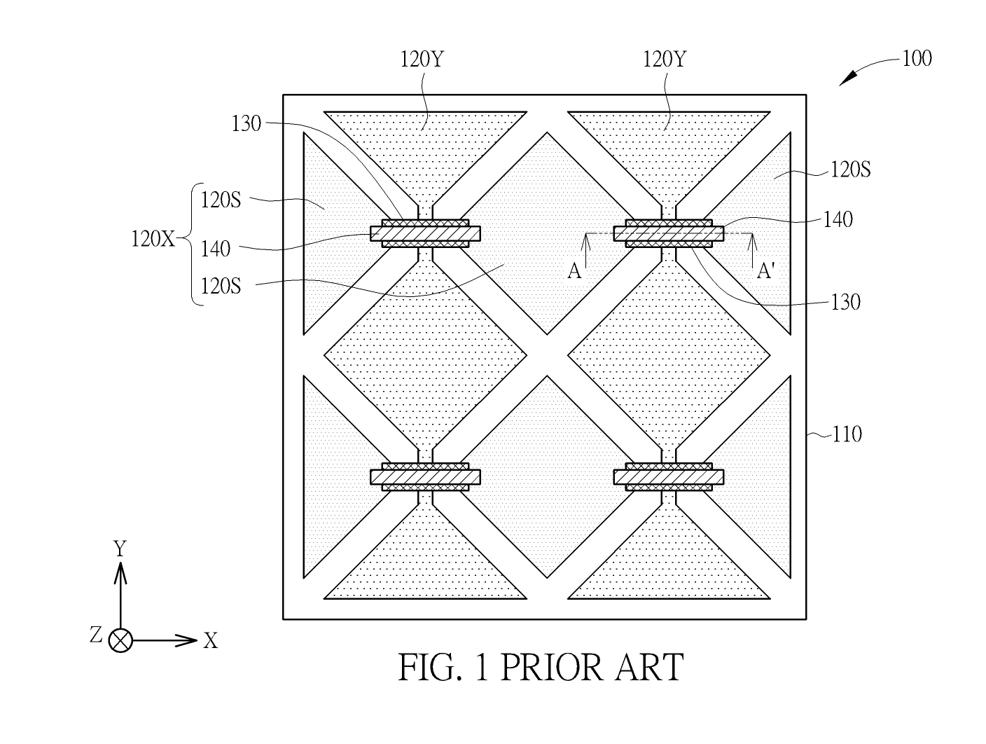

FIG. 2 is a cross-sectional view taken along the cross line A-A′ in FIG. 1.

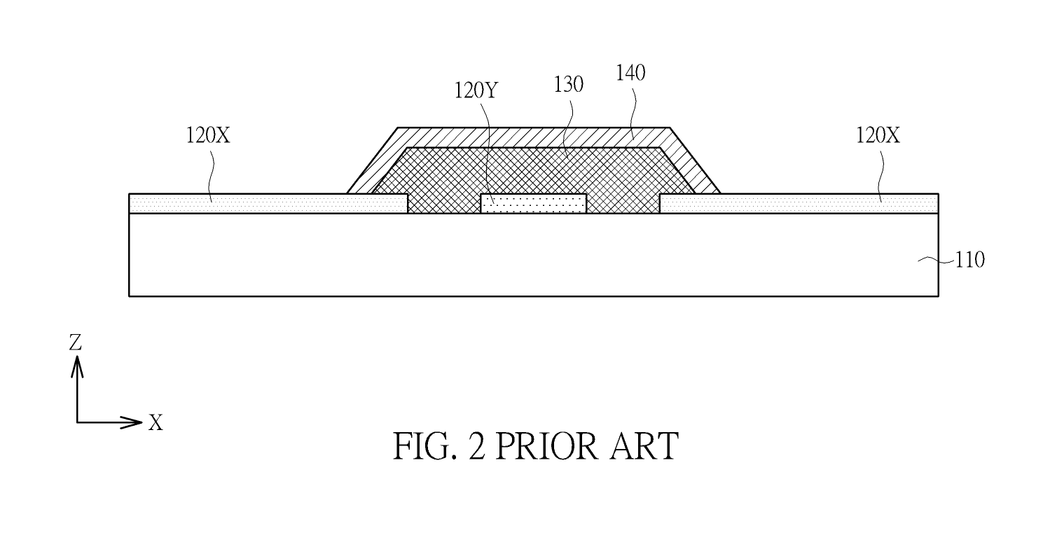

FIG. 3 is a diagram illustrating a touch panel in accordance with a first preferred embodiment of the present invention.

FIG. 4 is a cross-sectional view taken along the cross line B-B′ in FIG. 3.

FIG. 5 is a diagram illustrating a touch panel in accordance with a second preferred embodiment of the present invention.

FIG. 6 is a diagram illustrating a touch panel in accordance with a third preferred embodiment of the present invention.

FIG. 7 is a diagram illustrating a touch panel in accordance with a fourth preferred embodiment of the present invention.

FIG. 8 is a diagram illustrating a touch panel in accordance with a fifth preferred embodiment of the present invention.

FIG. 9 is a cross-sectional view taken along the cross line C-C′ in FIG. 8.

FIG. 10 is a diagram illustrating a touch panel in accordance with a sixth preferred embodiment of the present invention.

FIG. 11 is a cross-sectional view taken along the cross line D-D′ in FIG. 10.

FIG. 12 is a diagram illustrating a touch panel in accordance with a seventh preferred embodiment of the present invention.

FIG. 13 is a diagram illustrating a touch panel in accordance with an eighth preferred embodiment of the present invention.

### DETAILED DESCRIPTION

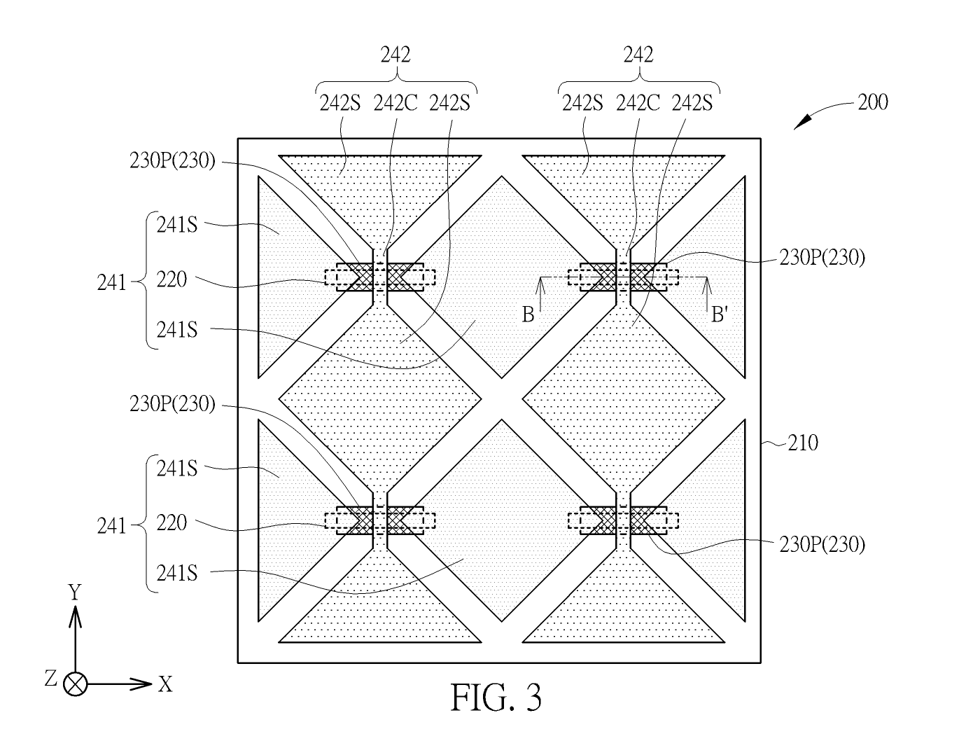

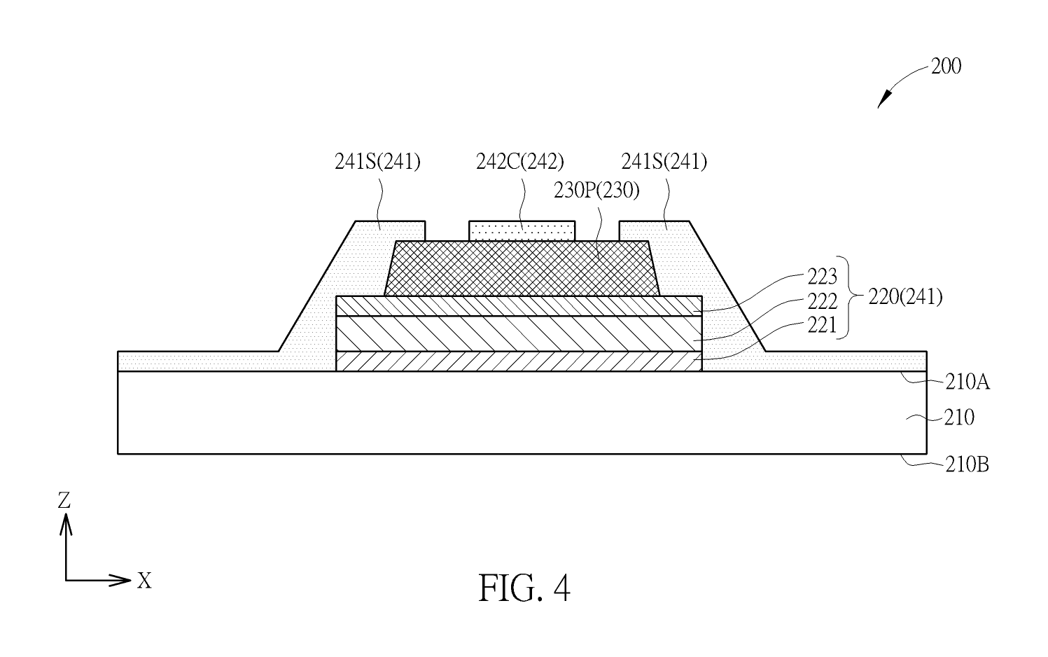

Referring to FIG. 3 and FIG. 4, FIG. 3 is a diagram illustrating a touch panel in accordance with the first preferred embodiment of the present invention, and FIG. 4 is a cross-sectional view taken along the cross line B-B′ in FIG. 3. To provide an easy understanding of the present invention, the preferred embodiments of the present invention are illustrated in accordance with accompanying drawings. Please note that those accompanying drawings are only for illustration and the scale thereof can be further modified according to different design considerations. As shown in FIG. 3 and FIG. 4, the present invention provides a touch panel 200, which comprises a substrate 210, at least one first axis electrode 241, at least one second axis electrode 242 and an insulation structure 230. The touch panel 200 in the present embodiment has a plurality of the first axis electrodes 241 and a plurality of the second axis electrodes 242 arranged to cross each other for touch sensing, but not limited thereto. The substrate 210 includes a top surface 210A and a bottom surface 210B. The substrate 210 can include a glass substrate, such as a cover glass; a plastic substrate, such as a polyethylene terephthalate (PET) substrate, a polyethersulfone (PES) substrate, a polyimide (PI) substrate, a polycarbonate (PC) substrate, a polyethylene naphthalate (PEN) substrate and a polymethyl methacrylate (PMMA) substrate; or substrates formed by other suitable materials. The first axis electrodes 241 are disposed on the top surface 210A of the substrate 210 and extend along a first direction X. Each of the first axis electrodes 241 comprises a plurality of first sub electrodes 241S and a plurality of connection structures 220. The first sub electrodes 241S are arranged in rows along the first direction X. Each of the connection structures is electrically connected to two adjacent first sub electrodes 241S along the first direction X, and is at least partially disposed between each of the first sub electrodes 241S and the substrate 210. The second axis electrodes 242 are disposed on the substrate and extend along a second direction Y, wherein the first direction X is not parallel to the second direction Y. In the present embodiment, the first direction X is substantially perpendicular to the second direction Y, but not limited thereto. The insulation structure 230 is at least partially disposed between the second axis electrodes 242 and the connection structures 220 of the first axis electrodes 241. The insulation structure 230 can comprise inorganic material, such as silicon nitride, silicon oxide and silicon oxynitride; organic material, such as acrylic resin; or other suitable materials. Furthermore, the insulation structure 230 of the present embodiment may include a plurality of insulation lumps 230P disposed on each of the connection structures 220 respectively. The first sub electrodes 241S contact a portion of the connection structures 220 uncovered by the insulation lumps 230P for being electrically connected to the connection structures 220. In the present embodiment, each of the insulation lumps 230P is disposed between each of the second axis electrodes 242 and each of the connection structures 220, but not limited thereto.

Referring to the fabrication process of each element in the touch panel 200 of the present embodiment, the connection structures 220 are first fabricated on the substrate 210, and then the insulation lumps 230P are sequentially formed on the connection structures 220. The first sub electrodes 241S and the second axis electrodes 242 are formed after the forming processes of the insulation lumps 230P, in such the first sub electrodes 241S can contact a portion of the connection structures 220 uncovered by the insulation structures 230 for being electrically connected to the connection structures 220. The first sub electrodes 241S and the second axis electrodes 242 can be fabricated through the same process, such as a process of patterning a transparent conductive film, but not limited thereto, so as to simplify the entire fabrication process. The aforementioned transparent conductive film can include indium tin oxide (ITO), indium zinc oxide (IZO), aluminum zinc oxide (AZO), or other suitable nontransparent conductive materials. Moreover, each of the second axis electrodes 242 comprises a plurality of second sub electrodes 242S arranged in lines along the second direction Y and at least one connection line 242C disposed between two adjacent second sub electrodes 242S for electrically connecting the second sub electrodes 242S. In view of each of the second axis electrodes 242, the second sub electrodes 242S and the connection line 242C are preferably fabricated integrally with the same material, but not limited thereto. In other preferred embodiments of the present invention, the second sub electrodes 242S and the connection line 242C can also be fabricated in different processes by using different materials. In the present invention, since the connection structures 220 are directly formed on the substrate 210, the connection structures 220 can effectively avoid defects, such as the fracture of the connection structures 220, caused by the thickness of the insulation lumps 230P, especially in comparison with the conventional connection lines crossing over the insulators, thereby achieving preferable reliability and yield of the touch panel 200.

In the present embodiment, each of the connection structures 220 comprises a low reflective layer 221 and a first metal layer 222. The main component of the first metal layer 222 may comprise at least one of metals selected from aluminum (Al), copper (Cu), silver (Ag), chromium (Cr), titanium (Ti), Molybdenum (Mo), gold (Au), and nickel (Ni), a composition or an alloy of aforementioned materials, but not limited thereto. The low reflective layer 221 can comprise metal oxide, metal nitride, metal oxynitride or other suitable low reflective materials. Since the low reflective layer 221 is disposed between the substrate 210 and the first metal layer 222, the low reflective layer 221 can reduce the visibility of the metal material in the connection structures 220, for example the first metal layer 222. Thus, while regarding the bottom surface 210B as an operation surface, the first metal layer 222 will hardly be seen therefrom. In this way, the present invention can both utilize the metal material in the connection structures 220 to reduce the entire impedance of the first axis electrodes 241, and also provide a preferable appearance to the touch panel 200 by using the low reflective layer 221. Preferably, the low reflective layer 221 entirely covers the first metal layer 222 in a direction Z which is perpendicular to the substrate 210 for reducing the visibility of the first metal layer 222, but it is not limited thereto. Furthermore, each of the connection structures 220 optionally further comprises a second metal layer 223 disposed on the first metal layer 222, and the first metal layer 222 is sandwiched between the second metal layer 223 and the low reflective layer 221. The second metal layer 223 can comprise a metal conductive material which is less oxidizable under general environment, such as molybdenum, titanium, chromium or other suitable metal conductive materials, in comparison with the first metal layer 222. The second metal layer 223 performs a shielding for the first metal layer 222 and prevents the first metal layer 222 from suffering possible defects caused by thermal stress, such as hillock. In other words, if the material used in the first metal layer 222 does not involve in aforementioned oxidization, thermal stress and other related issues, the connection structures 220 can also be consisted of the first metal layer 222 and the low reflective layer 221 without any other metal layers. Also, the low reflective layer 221 can comprise oxide, nitride, or nitrous oxide of a metal selected from the first metal layer 222 or the second metal layer 223, thus that the low reflective layer 221, the first metal layer 222 and the second metal layer 223 can all be fabricated sequentially in the same fabrication process, such as physical vapor deposition (PVD), using relatively fewer kinds of targets to achieve the fabrication through a simplified and time-saving process, but it is not limited thereto. As an example, the first metal layer 222 can comprise aluminum with relatively low resistivity, the second metal layer 223 can comprise molybdenum to prevent the first metal layer 222 from the oxidization and hillock issues, and the low reflective layer 221 can comprise a low reflective material including molybdenum oxide, molybdenum nitride or molybdenum oxynitride to reduce the visibility of the first metal layer 222, the second metal layer 223, or both of the first metal layer 222 and second metal layer 223. In other embodiment, the connection structure 220 can be fabricated in the shape of a mesh. Namely, each of the connection structures 220 can comprise a mesh connection structure, which can also reduce the visibility of the connection structure 220.

In following paragraphs, various practical examples of the touch panel in the present invention have been detail. In order to simplify the description, the following description will only detail the dissimilarities among different embodiments and the identical features will not be redundantly described. Please note that the identical components in each of the following embodiments are marked with identical symbols, so as to be easy to compare the differences therebetween.

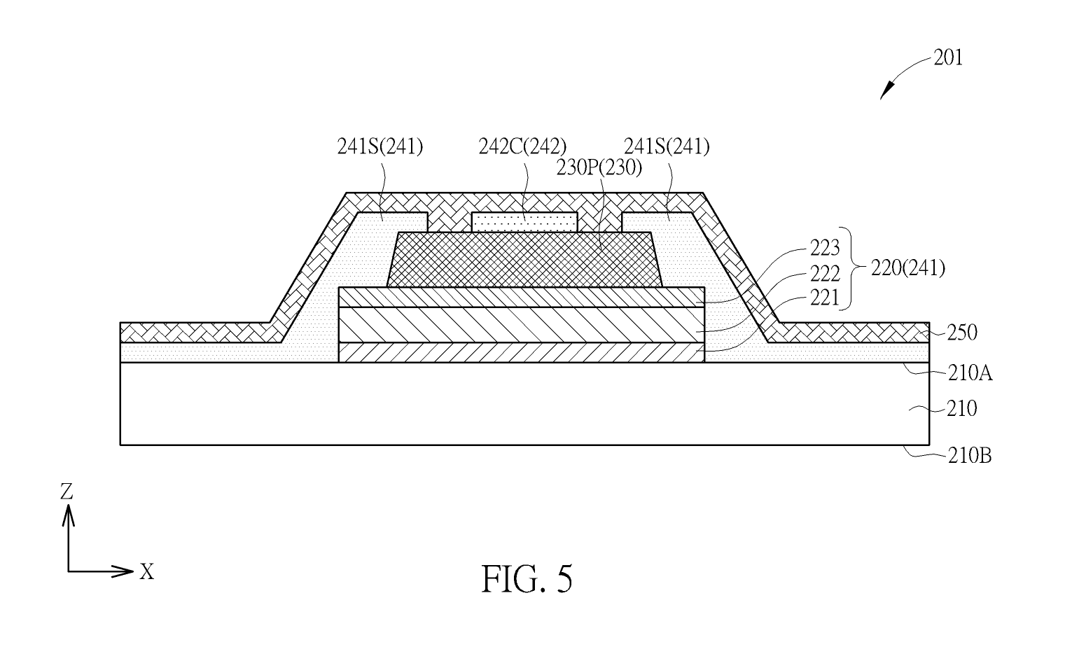

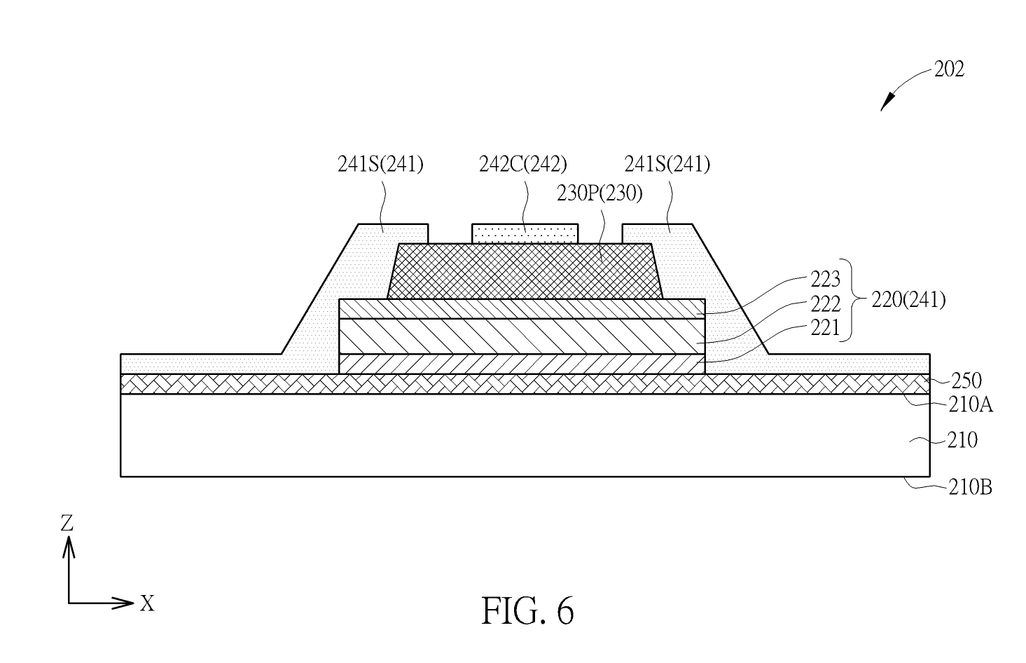

Referring to FIGS. 5 and 6, FIG. 5 is a diagram illustrating a touch panel 201 in accordance with the second preferred embodiment of the present invention, and FIG. 6 is a diagram illustrating a touch panel 202 in accordance with the third preferred embodiment of the present invention. As shown in FIG. 5 and FIG. 6, differences between the present embodiments and the first preferred embodiment is characterized in the touch panel 201 and the touch panel 202 both comprise a matt layer 250 disposed on the substrate 210 respectively. Except the visibility of first metal layer 222, profiles of the first axis electrodes 241 and the second axis electrode 242 may also interfere with the visual effect of the touch panel. Hence, the matt layer 250 can be further disposed on the touch panel to improve the visual effect. In the present invention, as shown in FIG. 5, the matt layer 250 can entirely cover a touch region of the touch panel 201. Namely, the matt layer 250 is disposed on the first axis electrodes 241 and the second axis electrodes 242, and the first axis electrodes 241 and the second axis electrodes 242 are sandwiched between the matt layer 250 and the substrate 210, but not limited thereto. As shown in FIG. 6, in the touch panel 202, the matt layer 250 can also be disposed on the substrate 210. The matt layer 250 is disposed between the substrate 210 and the first axis electrodes 241, and the matt layer 250 may be disposed between the substrate 210 and the second axis electrodes 242. Moreover, the matt layer 250 can comprise general insulation material, such as silicon oxide, silicon nitride, silicon oxynitride, silica-alumina or a stack of at least two of aforementioned materials. Also, the touch panel of the present invention according to various practical examples as described below can optionally dispose said matt layer based on other requirement of design, thus to achieve improved visual effect.

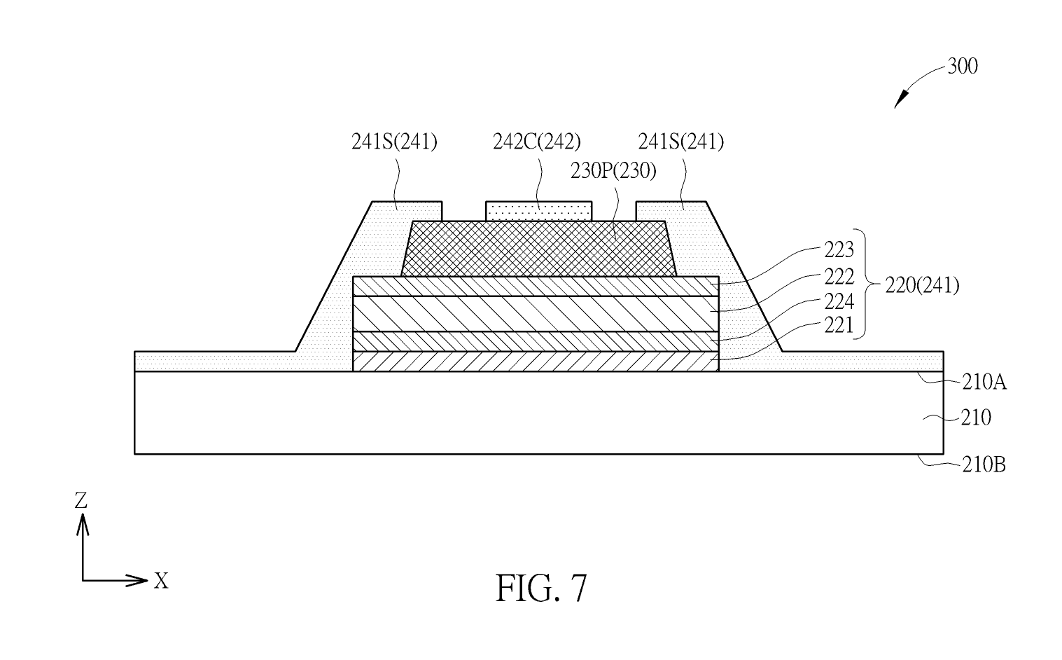

Referring to FIG. 7, FIG. 7 is a diagram illustrating a touch panel in accordance with the fourth preferred embodiment of the present invention. As shown in FIG. 7, the present embodiment provides a touch panel 300. Contrast to the first preferred embodiment, the connection structure 220 in the touch panel 300 further comprises a third metal layer 224 disposed between the first metal layer 222 and the low reflective layer 221. The third metal layer 224 can comprise metal conductive material, such as molybdenum, titanium, chromium, or other suitable metal conductive materials. The third metal layer 224 can function as a stress buffer between the first metal layer 222 and the low reflective layer 221, thereby preventing the first metal layer 222 from peeling and the fracture issues on the low reflective layer 221. The third metal layer 224 and the second metal layer 223 can be fabricated by the same metal material, but not limited thereto. The low reflective layer 221 can comprise oxide, nitride, or oxynitride of a metal material selected from the metal materials of first metal layer 222, the second metal layer 223 or the third metal layer 224, thus that the low reflective layer 221, the first metal layer 222, the second metal layer 223, and the third metal layer 224 can all be fabricated sequentially in the same fabrication process, such as physical vapor deposition, using fewer kinds of targets to achieve the fabrication through a simplified and time-saving process, but not limited thereto. As an example, the first metal layer 222 can comprise aluminum or aluminum alloy with relatively low resistivity, the second metal layer 223 and the third metal layer 224 can comprise molybdenum or molybdenum alloy to prevent the first metal layer 222 from the oxidization and hillock issues, and the low reflective layer 221 can comprise a low reflective material including molybdenum oxide, molybdenum alloy oxide, molybdenum nitride, molybdenum alloy nitride, molybdenum alloy oxynitride, or molybdenum oxynitride to reduce the visibility of the first metal layer 222, the second metal layer 223, and the third metal layer 224.

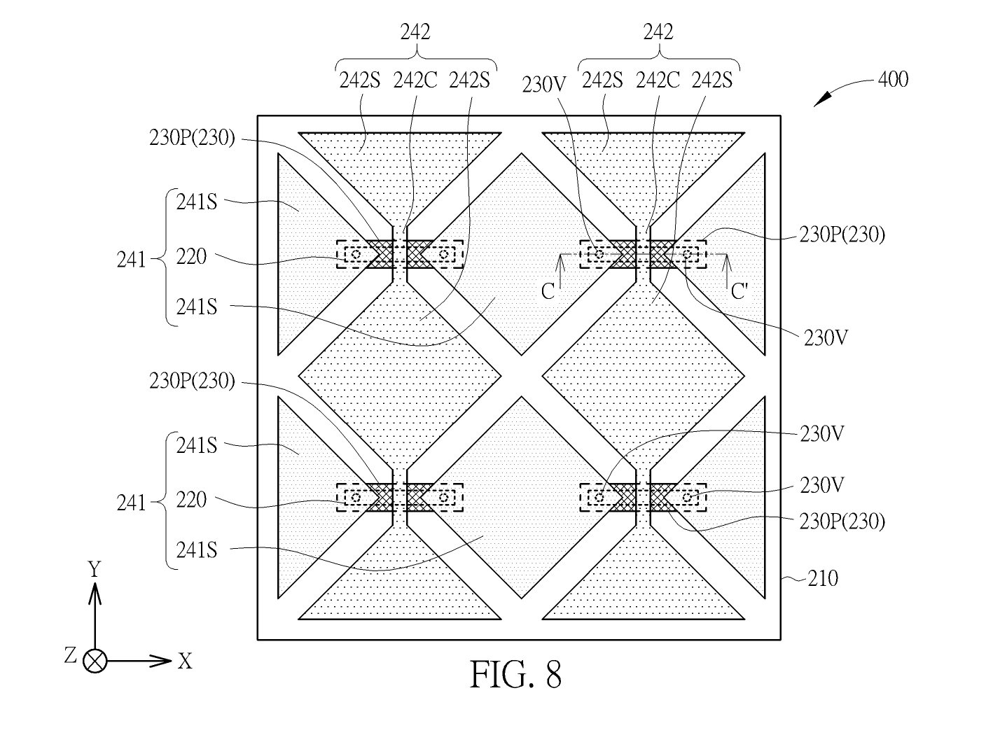

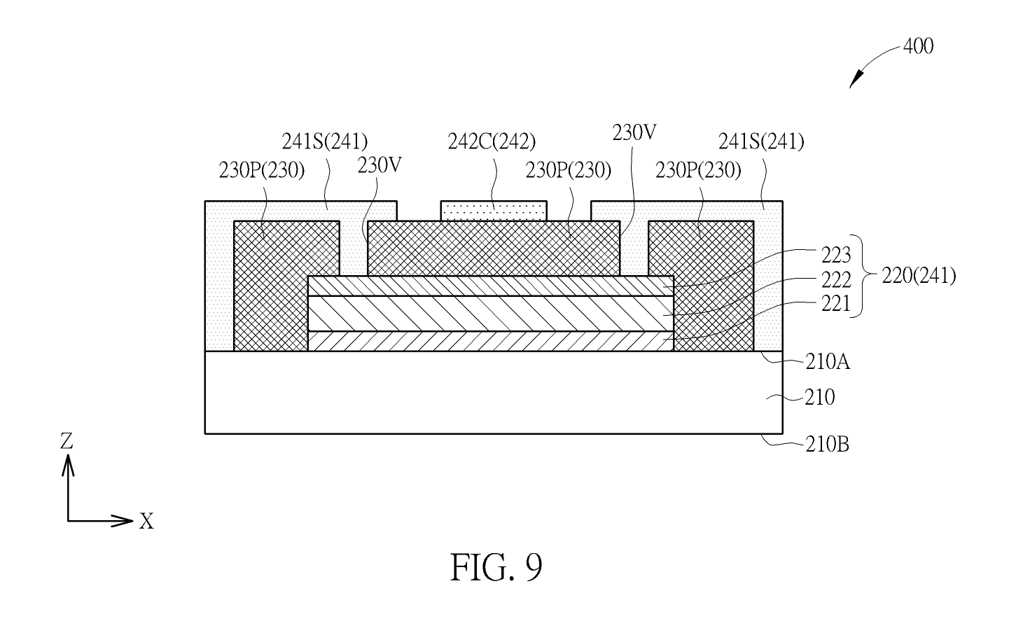

Referring to FIG. 8 and FIG. 9, FIG. 8 is a diagram illustrating a touch panel in accordance with the fifth preferred embodiment of the present invention, and FIG. 9 is a cross-sectional view taken along the cross line C-C′ in FIG. 8. As shown in FIG. 8 and FIG. 9, the present embodiment provides a touch panel 400, and difference between the first preferred embodiment and the present embodiment is characterized in that each of the insulation lumps 230P in the present embodiment covers two ends of each of the connection structures 220 in the direction X from the vertical projected direction Z, each of the insulation lumps 230P is disposed on the connection structures 220 and the substrate 210, and each of the insulation lumps 230P is at least partially disposed between each of the first sub electrodes 241S and the substrate 210. Each of the insulation lumps 230P comprises at least two contact openings 230V, each of the contact openings 230V at least partially exposes the connection structure 220 corresponding thereto, and each of the first sub electrodes 241S contacts the corresponding connection structure 220 through the contact openings 230V for electrical connection. In other words, each of the first sub electrodes 241S is electrically connected to the corresponding connection structure 220 by contacting a portion of the corresponding connection structure 220 exposed by the contact openings 230V. With such insulation lump 230P which covers the connection structures 220, it is sufficient to keep the connection structures 220 from damage of etchants, such as aqua regia, during the fabrication of the first sub electrodes 241S and the second axis electrodes 242. It is noted that, except the size and the installation of the insulation lumps 230P of the touch panel 400, other features, installations and materials of each element in rest parts of the present embodiment are similar to aforementioned first preferred embodiment, and will not be further detail herein.

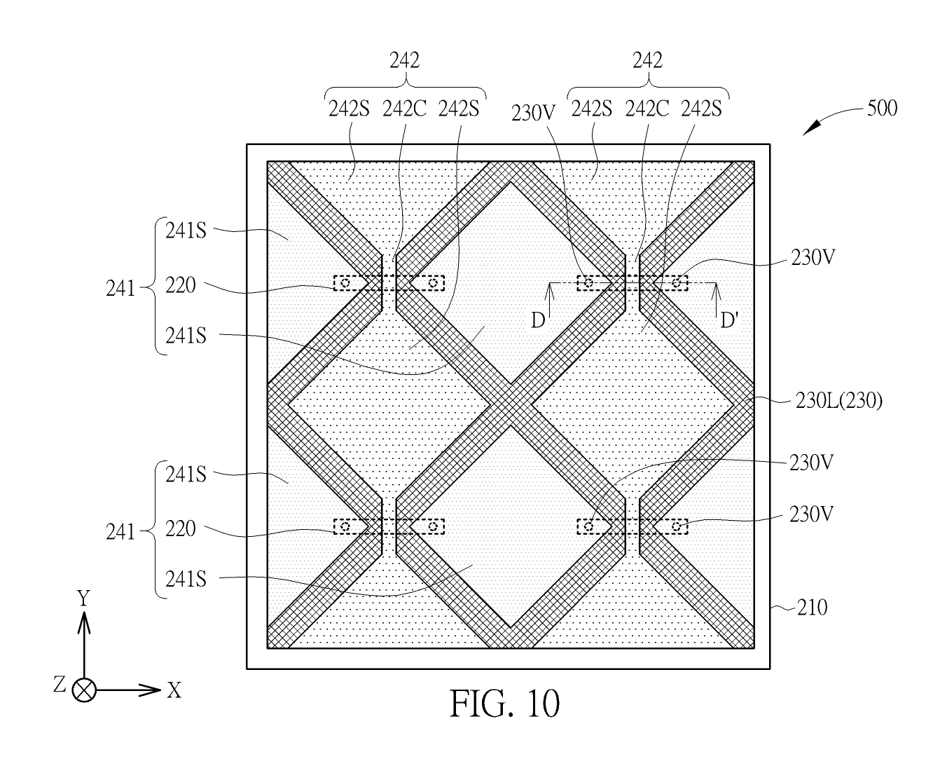

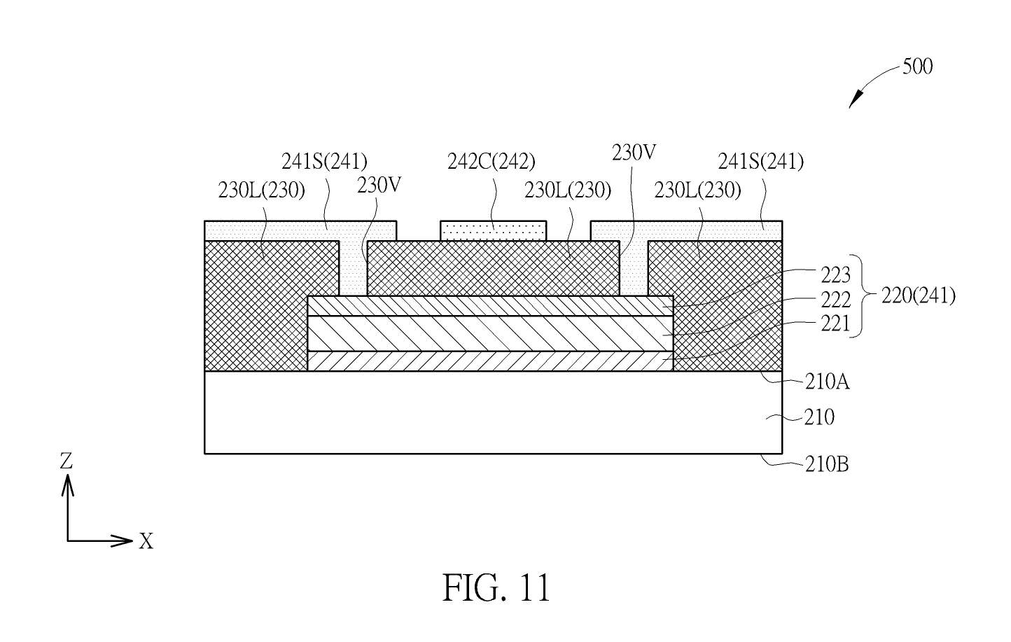

Referring to FIG. 10 and FIG. 11, FIG. 10 is a diagram illustrating a touch panel in accordance with the six preferred embodiment of the present invention, and FIG. 11 is a cross-sectional view taken along the cross line D-D′ in FIG. 10. As shown in FIG. 10 and FIG. 11, the present embodiment provides a touch panel 500, and the difference between the first preferred embodiment and the present embodiment is characterized in that the insulation structure 230 of the present embodiment entirely covers the connection structures 220 and the substrate 210. In other words, the insulation structures 230 is an insulation layer 230L disposed on the connection structures 220 and the substrate 210. The insulation layer 230L comprises a plurality of the contact openings 230V corresponding to two ends of each of the connection structures 220, each of the contact opening 230V at least partially exposes the corresponding connection structure 220, and each of the first sub electrodes 241S contacts the corresponding connection structures 220 through the contact openings 230V for electrical connection. In other words, each of the first sub electrodes 241S is electrically connected to the corresponding connection structure 220 by contacting a portion of the corresponding connection structure 220 exposed by the contact openings 230V. With such insulation structures 230 of the present embodiment entirely covering the connection structures 220, except for the contact openings 230V, it is sufficient to keep the connection structures 220 from damage of etchants, such as aqua regia, during the fabrication of the first sub electrodes 241S and the second axis electrodes 242.

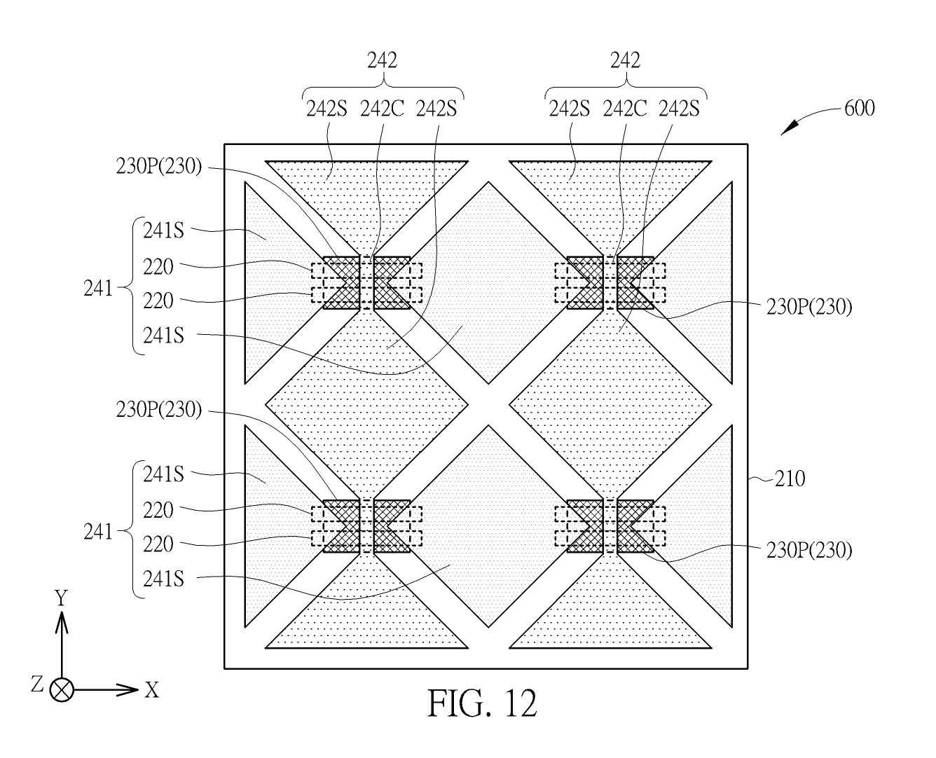

Referring to FIG. 12, FIG. 12 is a diagram illustrating a touch panel in accordance with the seventh preferred embodiment of the present invention. As shown in FIG. 12, the present embodiment provides a touch panel 600, the differences between the first preferred embodiment and the present embodiment is characterized in electrically connecting two adjacent first sub electrodes 241S through at least two connection structures 220 in the touch panel 600. With such arrangement, the present embodiment can avoid the disconnection problem while one of the connection structures 220 losses its function and leads to serious effects to the electric property of the first axis electrodes 241, thereby significantly increasing the reliability of the touch panel 600.

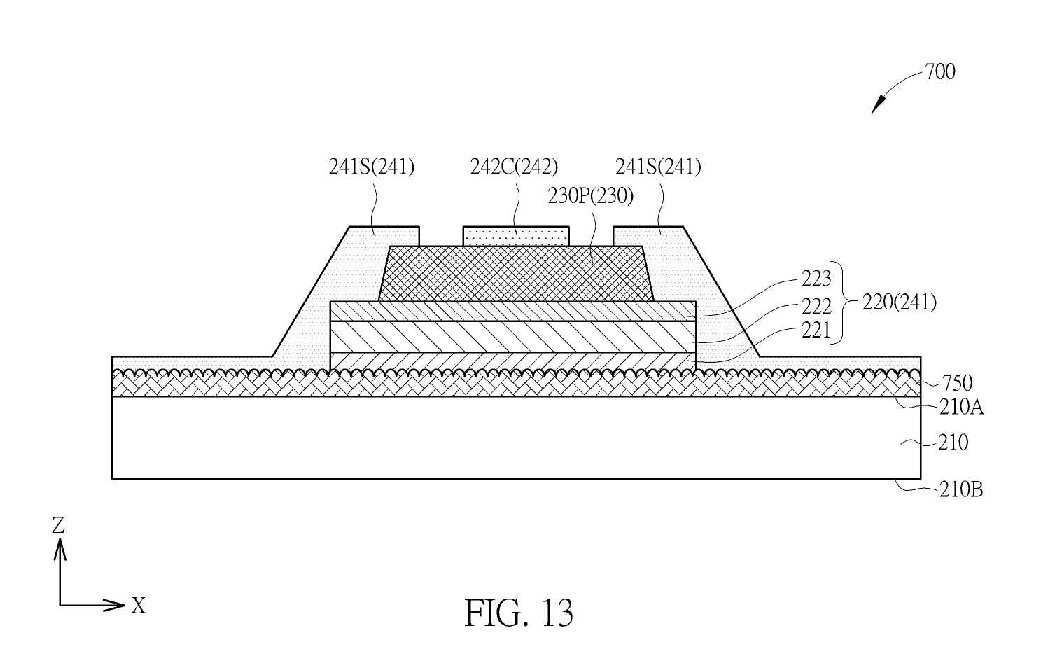

Referring to FIG. 13, FIG. 13 is a diagram illustrating a touch panel in accordance with the eighth preferred embodiment of the present invention. As shown in FIG. 13, the present embodiment provides a touch panel 700, the differences between the first preferred embodiment and the present embodiment is characterized in the touch panel 700 comprises a strengthening layer 750 disposed between the substrate 210 and the first axis electrodes 241 and the second axis electrodes 242. The strengthening layer 750 comprises the organic material, the inorganic material, the composite thereof or the stack structure thereof. Accordingly, the substrate 210 has enhanced anti-crash ability with the strengthening layer 750.

In the present embodiment, the strengthening layer 750 comprises a thickness between 0.4 micrometer (um) and 50 um. In addition, the strengthening layer 750 comprises a rough surface through a surface treatment, like plasma treatment or nano-imprint, to reduce the visibility of the first metal layer 222, the second metal layer 223, or both of the first metal layer 222 and second metal layer 223. In other embodiment, the strengthening layer 750 without the rough surface can be provided to enhance anti-crash ability.

To summarize the aforementioned paragraphs, the touch panel of the present invention comprises a metal layer and a low reflective layer disposed in the connection structure which electrically connects two adjacent sub electrodes, so that, the touch panel can utilize the metal material in the connection structures to reduce the impedance of the first axis electrodes, and can also reduce the visibility of the connection structures. In addition, each of the connection structures of the present invention is at least partially disposed between the each of the sub electrodes and the substrate, in such it can avoid defects of the connection structure, such as hillock, caused by the insulation structures, so as to successfully enhance the reliability and the yield of the touch panel.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A touch panel, comprising:
a substrate;
a plurality of first axis electrodes, disposed on the substrate and extending along a first direction, each of the first axis electrodes comprising:
a plurality of first sub electrodes; and
a plurality of connection structures, each of the connection structures at least partially disposed between each of the first sub electrodes and the substrate and electrically connected to two adjacent first sub electrodes, and each of the connection structures comprising:
a low reflective layer; and
a first metal layer, wherein the low reflective layer is disposed between the substrate and the first metal layer;
a plurality of second axis electrodes, disposed on the substrate and extending along a second direction not parallel to the first direction; and
an insulation structure, at least partially disposed between the second axis electrodes and the connection structures.

2. The touch panel according to claim 1, wherein the low reflective layer comprises metal oxide, metal nitride, or metal oxynitride.

3. The touch panel according to claim 1, wherein each of the connection structures further comprises a second metal layer, and the first metal layer is sandwiched between the second metal layer and the low reflective layer.

4. The touch panel according to claim 1, wherein the insulation structure comprises a plurality of insulation lumps disposed on the connection structures respectively, and the first sub electrodes contact a portion of the connection structures uncovered by the insulation lumps.

5. The touch panel according to claim 1, wherein the insulation structure comprises a plurality of insulation lumps respectively disposed on the connection structures and the substrate, each of the insulation lumps comprises at least two contact openings, and each of the first sub electrodes contacts each of the connection structures exposed by the connection openings.

6. The touch panel according to claim 1, wherein the insulation structure comprises an insulation layer disposed on the connection structures and the substrate, the insulation layer comprises a plurality of contact openings corresponding to two ends of each of the connection structures, and each of the first sub electrodes contacts the connection structures exposed by the contact openings.

7. The touch panel according to claim 1, wherein two adjacent first sub electrodes along the first direction are electrically connected to each other through at least two of the connection structures.

8. The touch panel according to claim 1, wherein each of the connection structures further comprises a third metal layer sandwiched between the first metal layer and the low reflective layer.

9. The touch panel according to claim 8, wherein the low reflective layer comprises oxide, nitride or oxynitride of the first metal layer or the third metal layer.

10. The touch panel according to claim 1, wherein each of the connection structures comprises a mesh connection structure.

11. The touch panel according to claim 1, further comprising a matt layer disposed on the first axis electrodes and the second axis electrodes, wherein the first axis electrodes and the second axis electrodes are disposed between the matt layer and the substrate.

12. The touch panel according to claim 1, further comprising a matt layer disposed on the substrate, wherein the matt layer is disposed between the first axis electrodes and the substrate, and also disposed between the second axis electrodes and the substrate.
